(19) United States
(12) Patent Application Publication
(10) Pub. No.: US 2015/0178259 A1
(43) Pub. Date: Jun. 25, 2015

(54) ANNOTATION HINT DISPLAY

(71) Applicant: Microsoft Corporation, Redmond, WA (US)

(72) Inventors: Patrick Davis, Seattle, WA (US); Tristan Davis, Redmond, WA (US)

(73) Assignee: Microsoft Corporation, Redmond, WA (US)

(21) Appl. No.: 14/135,083

(22) Filed: Dec. 19, 2013

(51) Int. Cl. G06F 17/24; H04L 29/06

(52) U.S. Cl. CPC G06F 17/241; H04L 67/42

(57) ABSTRACT

An annotation hint may be displayed in conjunction with an application enabling document interaction in order to indicate metadata information. The application may determine metadata information, such as a status, an amount, and/or a context of metadata associated with annotations within a document, and may display the annotation hint to one or more users to indicate the annotation metadata information. The annotation hint may be displayed through a user interface associated with the application near a location within the document where the metadata is located. The annotation hint may indicate the metadata information without the one or more users having to hover over and/or select the annotation hint, enabling implementation when the application is executed on a touch-enabled device. The one or more users may also be enabled to interact through the user interface to customize annotation hints and to select another annotation hint to replace the displayed annotation hint.

### BACKGROUND

Applications such as word-processing, spreadsheet, and presentation applications enable interaction with documents, and may include commenting features to enable users to annotate a document with comments. The application may display a comment hint within the document to indicate to a reading user (e.g., a consuming user, a collaborative author, an editor, or any number of other user types) that an annotation has been made. The comment hint may be displayed in conjunction with a location in a document where an annotation was made. The comment hint may indicate that there is an annotation, as well as metadata associated with a portion of the document, generally from a reviewer or co-author of the document, at the location of the document where the hint is displayed. A hover action over the hint may be performed by a user to reveal the metadata. However, for word-processing applications executed on a touch-enabled device, a hover action is no longer available. As a result, when the user is accessing the document through the touch-enabled device, the hint may no longer give indication of what the metadata might be and the user may have to invoke the hint to reveal the metadata.

Additionally, on devices with smaller screen sizes, there may not be enough screen space on the user interface to provide a detailed comment hint. Another challenge with conventional technologies is that beside the fact that metadata (the anchor location and the actual comment text) is hidden and a hover action is not available to touch. Thus, more of a commitment with a touch is needed. A user may still even have to hover at all to start to glean any insight other than a rough location from a hint.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to display of an annotation hint in conjunction with a document processing application such as word-processing, spreadsheet, and presentation applications that enable annotation of a document. The application may determine metadata information associated with the document and/or annotation, such as a status, an amount, and/or a context of annotation metadata, and may display an annotation hint to a user to indicate the metadata information. The annotation hint may be displayed through a user interface associated with the application in conjunction with a location within the document where the metadata is located. In some embodiments, the annotation hint may indicate the metadata information without a user having to perform a hover action over the annotation hint or having to select the annotation hint. In further embodiments, users may be enabled to interact through the user interface to customize and augment annotation hints, and to select another annotation hint to customize an annotation hint, and to replace a displayed annotation hint in response to an invocation of the metadata by the users.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 includes a conceptual diagram illustrating an example networked configuration environment, where embodiments may be implemented;

FIGS. 2-4 illustrate examples of annotation hints displayed on a document of word-processing, spreadsheet, and presentation applications to indicate metadata information associated with an annotation;

FIG. 5 is a networked environment, where a system according to embodiments may be implemented;

FIG. 6 is a block diagram of an example computing operating environment, where embodiments may be implemented; and

FIG. 7 illustrates a logic flow diagram of a method to display an annotation hint in conjunction with a document.

### DETAILED DESCRIPTION

As briefly described above, an annotation hint may be displayed in conjunction with a document accessed through an application such as a word-processing application. The application may determine metadata information, such as a status, an amount, and/or a context of metadata associated with a document of the word-processing application, and display an annotation hint to one or more users to indicate the metadata information. The annotation hint may be displayed through a user interface associated with the word-processing application near a location within the document where the metadata is located. Users may also be enabled to interact with the document through the user interface to customize the annotation hints, and to select another annotation hint to replace the displayed annotation hint in response to invocation of the metadata by the users. The metadata may be shown with the hints, as well as hints themselves, both of which may be customizable.

A hint may also provide a representation of the metadata, so that the interaction is not needed. For example, the hint may include iconography that represents the metadata. Additionally, there may be actions other than hover that may initiate the presentation of the metadata, for example, a voice query or a gesture. Furthermore, the hint may also provide a representation of the metadata to eliminate a need for interaction.

As mentioned previously, the annotation hint may indicate the metadata information without a user having to perform a hover action over the annotation hint or having to select the annotation hint, enabling implementation when the application is executed on a touch-enabled device. However, embodiments are not limited to touch-based technologies. Generally, having access to the metadata “at a glance” may be desirable for rapid consumption of the annotations. For example, a user may wish to know which comments are questions by visually scanning the hint, even before they get to the actual comment.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for display of an annotation hint on a document. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

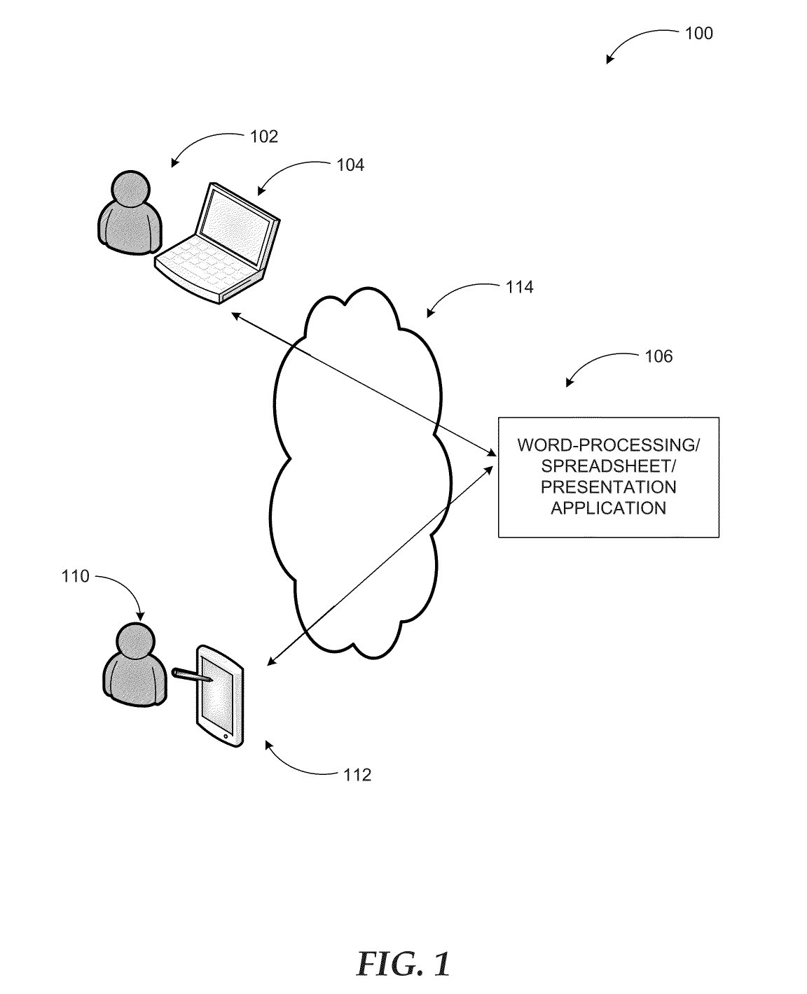

FIG. 1 includes a conceptual diagram illustrating an example networked configuration environment, where embodiments may be implemented. An application 106 such as a word-processing, a spreadsheet, or a presentation application may enable one or more users (e.g., 102, 110) to create, edit, and share documents. The users may execute the application 106 on one or more client devices, such as a desktop, a laptop, a tablet, a smart phone, or other similar device. Users may collaborate on documents to co-author and annotate shared documents. Documents maybe shared between the users over a network such as a cloud 114 to enable collaboration and co-authoring.

In one example embodiment, a user 102 may execute the application 106 on a laptop computer 104 to edit a document prepared by another user 110. While editing the document, the user 102 may insert one or more comments and annotations, which may be pieces and/or sub-pieces of metadata associated with content at one or more locations within the document. For example, the user 102 may insert a question about a first section of the document. The user 102 may also insert a comment about content or about typographical errors in a last section of the document. Once the user 102 has finished editing the document, the user 102 may share the document with the other user 110 via the cloud 114.

In order to access the edited document, the other user 110 may execute the application 106 to open to open the document on a touch-enabled device, such as a tablet 112. Upon opening the document, the application 106 may determine metadata information associated with the edited document to identify the annotations and annotation metadata. Example annotation metadata may include a status, an amount, and/or a context of the metadata. The status and amount of metadata may be determined mechanically by the application 106. The status of the metadata may include characteristics of annotations such as read, selected, new, and/or completed. The amount of metadata may include a number of pieces and/or sub-pieces of metadata, such as multiple related annotations. The context of the metadata may include a question, an urgency, a creation time, an author, a like, a dislike, a follow up needed indication, a task indicator, an assignment for action, a spelling error, a formatting error, a grammatical error, a typographical error, and comparable information. The context of the metadata may be determined by a contest processing module of the word-processing application configured to identify a context of annotations within the document.

In another example embodiment, when the user 102 opens the document, the application may display one or more annotation hints through a user interface associated with the application to indicate a presence of an annotation. The annotation hint may also provide an indication of the context of the metadata information without the user 102 having to invoke the annotation hint to expand the annotation hint to display more detailed information. The annotation hints may be displayed using a textual scheme, a graphical scheme, an animation scheme, a coloring scheme, a highlighting scheme, and/or a shading scheme to enhance the display of the annotation hints in the user interface. The annotation hints may further be displayed in conjunction with a location within the document where the metadata is located. For example, continuing from the previous example, a graphical icon with a question mark may be displayed in conjunction with the first section of the document to indicate the question within the content of the metadata. A graphical icon with a bold “T” may be displayed in conjunction with last section of the document to indicate the typographical error comments in the content of the metadata.

In some embodiments, the other user may be enabled customize displayed annotation hints. For example, after viewing an annotation hint, the other user 110 may select another annotation hint to replace the displayed annotation hint in response to invocation of the metadata by the user 102. The user 102 may interact with the user interface by a tap action, a swipe action, a mouse input, a pen input, and/or a keyboard input to make the selection. For example, the user 102 may invoke the metadata associated with the first section of the document. After reading the metadata, the user 102 may determine that the question presented is important and needs further attention. In response, the user 102 may select another annotation hint to indicate importance of the metadata, replacing the displayed annotation hint that indicated the metadata contained a question with an annotation hint indicating an importance.

While some current word-processing applications may display annotation hints in conjunction with a location in a document to indicate that there is metadata, a hover action over the hint has to be performed by a user to reveal the totality of the metadata. However, for document viewing applications executed on touch-enabled devices, such as the tablet 112, the hover action is no longer available. Additionally, on devices with smaller screen sizes, there may not be enough screen space to display detailed information about the metadata. As a result, the hint may no longer provide an indication of what the metadata might be and the user has to invoke the hint to reveal the metadata. Contrastingly, according to the embodiments described herein, the displayed annotation hints may indicate the metadata information in conjunction with a location in a document where the metadata is located without the user having to invoke the metadata.

The example systems in FIG. 1 have been described with specific servers, client devices, applications, and interactions. Embodiments are not limited to systems according to these example configurations. Annotation hint display in conjunction with a document viewing application may be implemented in configurations employing fewer or additional components and performing other tasks. Furthermore, specific protocols and/or interfaces may be implemented in a similar manner using the principles described herein.

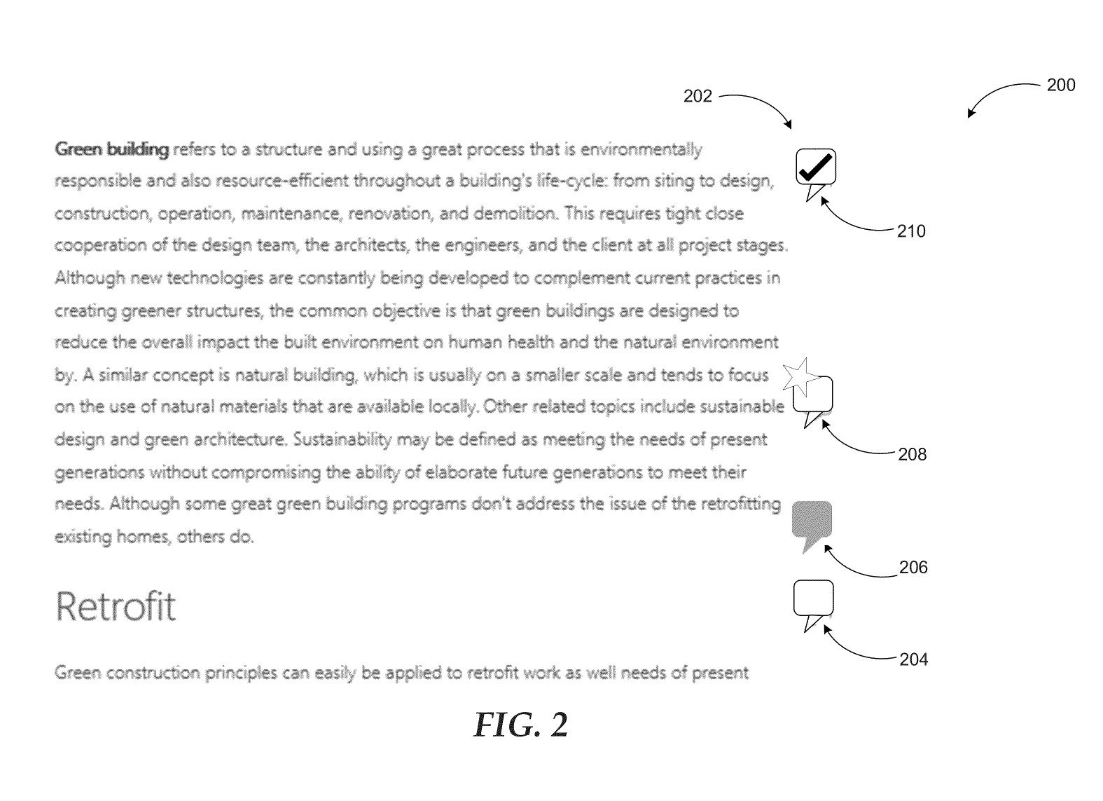

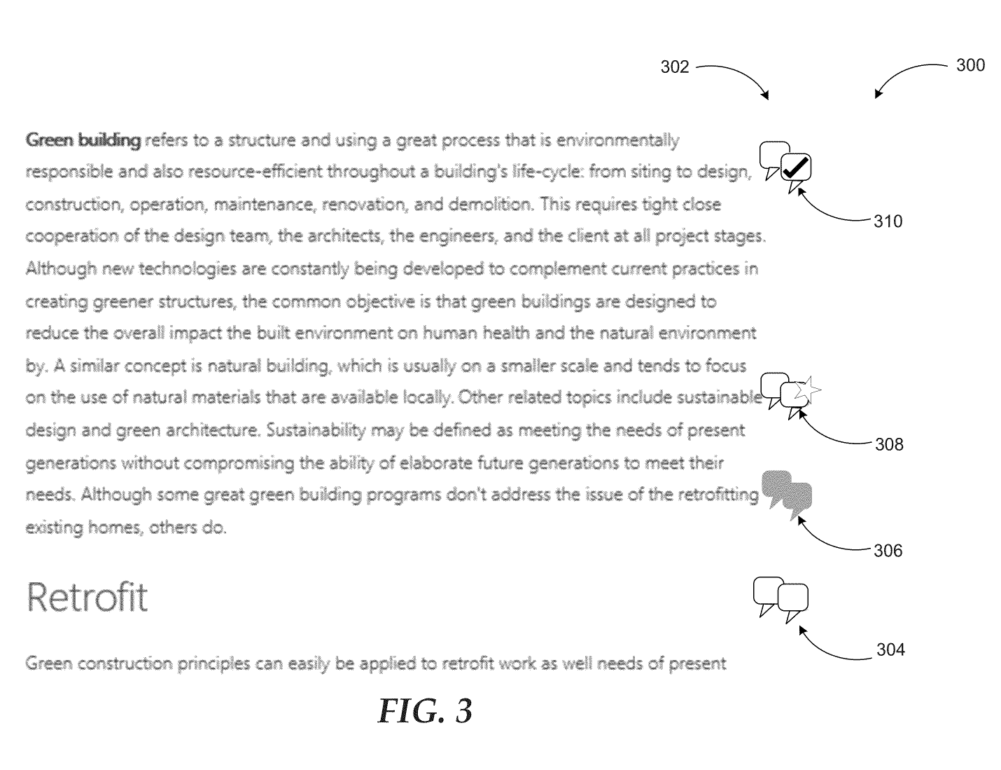

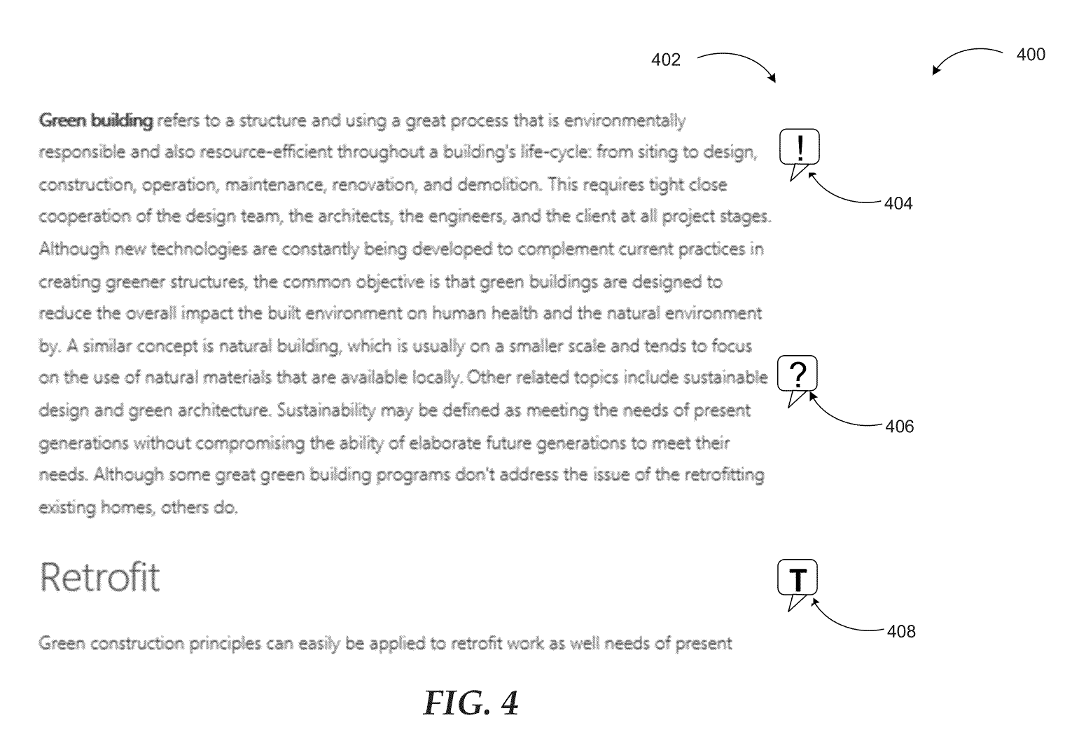

FIGS. 2-4 illustrate examples of annotation hints displayed through a user interface associated with a word-processing application to indicate metadata information. The annotation hints may be displayed in conjunction with one or more locations within the document where metadata is located. The annotation hints may indicate information about the metadata, such as a status, an amount, and a context of the metadata, without a user having to hover over and/or select the annotation hints. The annotation hints may be displayed using a textual scheme, a graphical scheme, an animation scheme, a coloring scheme, a highlighting scheme, and/or a shading scheme to enhance the display of the annotation hints in the user interface. The schemes may be pre-determined or defined by a user. For example certain colors may be selected to indicate an author's identity of an annotation.

In a first example, as shown in a diagram 200, annotation hints may be displayed to a user through a user interface 202 associated with a word-processing application in conjunction with one or more locations within the document where metadata is located. While the example document is shown on a word-processing application, other applications may also enable display of annotation hints associated with viewed content, such as spreadsheet, presentation, and web applications, for example. The annotation hints may indicate a status of the metadata, and the annotation hints may be displayed as graphical icons (e.g., 204-210) near a location of the metadata in the document. In an example graphical and shading scheme, an unshaded icon, such as icon 204, may indicate to a user that the metadata has been read. A shaded icon, such as icon 206, may indicate to the user that the metadata has been selected by the user. The icon 206 may be selected to remind the user that an action needs to be performed in response to the metadata, for example. An icon may display a symbol to indicate that a comment or annotation is new. For example, a star on an icon may indicate a new annotation. Additionally, schemes may be combined, such that an annotation hint may provide multiple pieces of information. For example an unshaded icon with a star, such as icon 208, may indicate to the user that the metadata is new and unread. An unshaded icon with a check mark, such as icon 210, may indicate to the user that an action in response to the metadata has been completed.

In some other embodiments, a color of the icon and/or outline of the icon may indicate which other user inserted the metadata at the location within the document. For example, a first reviewer of the document may be associated with a blue icon and a second reviewer of the document may be associated with a red icon, such that the color of the annotation hint may provide an indication to a reading user as to the author of a particular annotation. Additionally, the annotation hints may be displayed anywhere on the document, such as any side, top, or bottom margin near a location of the related content, and between lines or paragraphs of text, where applicable. In other applications, such as a spreadsheet application or presentation application, the annotation hints may be displayed in cells within a table, in pop-up panes, in text or comment boxes, and anywhere on a presentation slide, as some examples. A user may be able to customize a preferred placement of displayed annotation hints.

In a second example, as shown in a diagram 300, annotation hints may be displayed to a user on a document 302 viewed with a word-processing application in conjunction with one or more locations within the document where metadata is located. The annotation hints may indicate a status and an amount of metadata included with identified annotations, and the annotation hints may be displayed as graphical icons (e.g., 304-310). In an example scheme, two icons may be stacked together to indicate that there are multiple pieces and/or sub-pieces of metadata at a location in order to prevent clutter of the user interface. For example, two icons together may indicate multiple nested comments from two or more users related to a particular portion of the displayed content. In another example, two unshaded icons 304, may indicate to a user that there are two or more pieces and/or sub-pieces of metadata that have been read. Two shaded icons 306 may indicate to the user that there are two or more pieces and/or sub-pieces of metadata that have been selected by the user. The two shaded icons 306 may be selected to remind the user that one or more actions need to be performed in response to the metadata, for example. Two unshaded icons with an animated star 308 may indicate to the user that there are two or more pieces and/or sub-pieces of metadata that are new and unread. Two unshaded icons with a check mark 310, may indicate to the user that there are two or more pieces and/or sub-pieces of metadata and one or more actions in response to the metadata has been completed.

In a third example, as shown in a diagram 400, annotation hints may be displayed to a user on a document 402 in conjunction with one or more locations within the document where metadata is located. The annotation hints may indicate a context of the metadata and the annotation hints may be displayed as graphical icons (e.g., 404-410). A context processing module of the word-processing application may determine a context of the metadata in conjunction with a location within the document. For example, the context processing module may be configured to identify whether an annotation is new, whether an annotation includes positive or negative feedback, whether the annotation is related to another task, whether a question is asked, whether the annotation references a spelling or grammar issue, and whether the annotation is urgent or important, as some examples. The context processing module may identify keywords within the metadata to determine a context of the metadata. For example, keywords such as spelling, format, “typo,” or other similar key words identified in the annotation may prompt the context processing module to provide an annotation hint that indicates a spelling or formatting issue.

In an example annotation hint scheme providing a context of metadata, an icon with an exclamation point, such as icon 404, may indicate to a user that there is an urgency or importance associated with the content of the metadata. For example, a co-author may have noticed that a key aspect of an idea was left out of a proposal document that needs to be submitted by end of day and left a note of urgency within the metadata. As a result, the user may immediately invoke the metadata and perform any actions in response to the metadata, such as edit the proposal document to include the key aspect. An icon with a question mark, such as icon 406, may indicate to the user that there is a question in the content metadata. For example, a reviewer may have a question regarding a meaning of a sentence in the document. An icon with a large bold “T”, such as icon 408, may indicate to the user that there is a comment regarding a typographical error, or other spelling or grammar issue. For example, a word may be misspelled, a comma may be missing, and/or a syntax of a sentence may be incorrect. In other examples, a flag may be displayed with an annotation hint to indicate that the metadata is related to another task.

As described previously in a diagram 200, a color of the icons displayed may indicate one or more users that inserted the metadata at the location within the document. Furthermore, any graphical, shading, coloring, animation, or highlighting scheme may be used to provide annotation hints associated with a document. The scheme may be configurable by users and administrators interacting with the document. Additionally, the annotation hint scheme may match a theme of a viewed document. Furthermore, an annotation hint scheme may be selected to match a detected type of device and/or screen such that an icon size may be determined based on the detected device and screen size.

The examples in FIGS. 1 through 4 have been described with specific systems including specific applications, user interface displays, schemes, and configurations. Embodiments are not limited to systems according to these example configurations. Annotation hint display in conjunction with a location within a document may be implemented in configurations using other types of systems including specific applications, user interface displays, schemes, and configurations in a similar manner using the principles described herein.

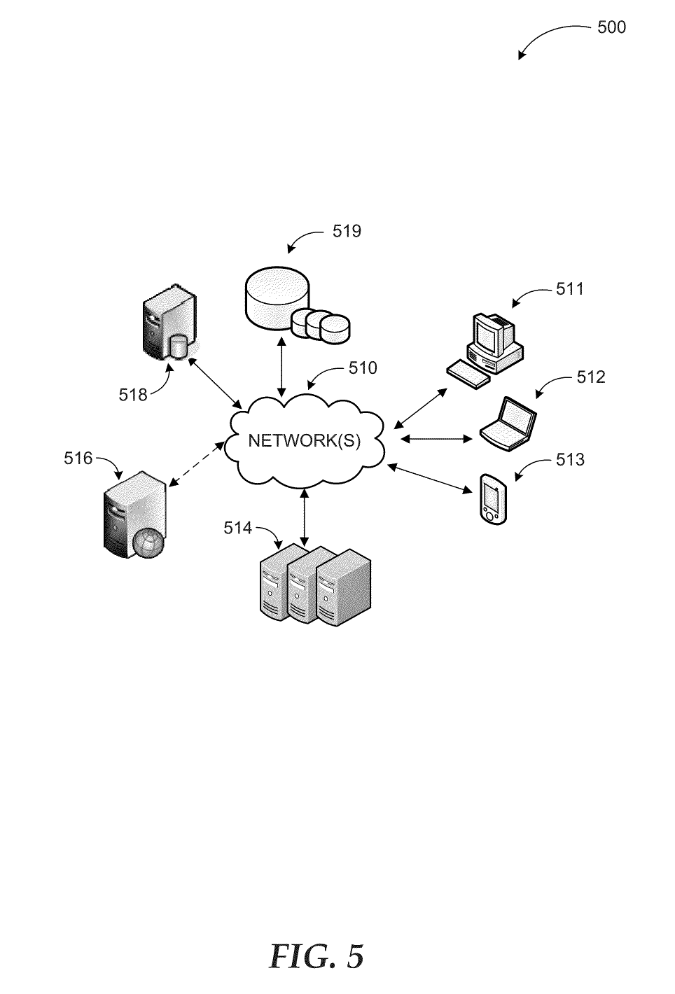

FIG. 5 is an example networked environment, where embodiments may be implemented. A system to display an annotation hint in conjunction with a document viewed on a word-processing, spreadsheet or presentation application may be implemented via software executed over one or more servers 514 such as a hosted service. The platform may communicate with client applications on individual computing devices such as a smart phone 513, a laptop computer 512, or desktop computer 511 (‘client devices’) through network(s) 510.

Client applications executed on any of the client devices 511-513 may facilitate communications via application(s) executed by servers 514, or on individual server 516. A word-processing application may be configured to determine metadata information associated with a document. The metadata information may include a status, an amount, and/or a context of the metadata. The document viewing application may also be configured display an annotation hint to one or more users through a user interface associated with the application to indicate the status, the amount, and/or the context of the metadata without invocation of the metadata. The annotation hint may be displayed in conjunction with a location within the document where the metadata is located. The application may further be configured to enable the one or more users to select and customize annotation hints. The application may retrieve relevant data from data store(s) 519 directly or through database server 518, and provide requested services (e.g. document editing) to the user(s) through client devices 511-513.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to implement a platform display an annotation hint in conjunction with a document. Furthermore, the networked environments discussed in FIG. 5 are for illustration purposes only. Embodiments are not limited to the example applications, modules, or processes.

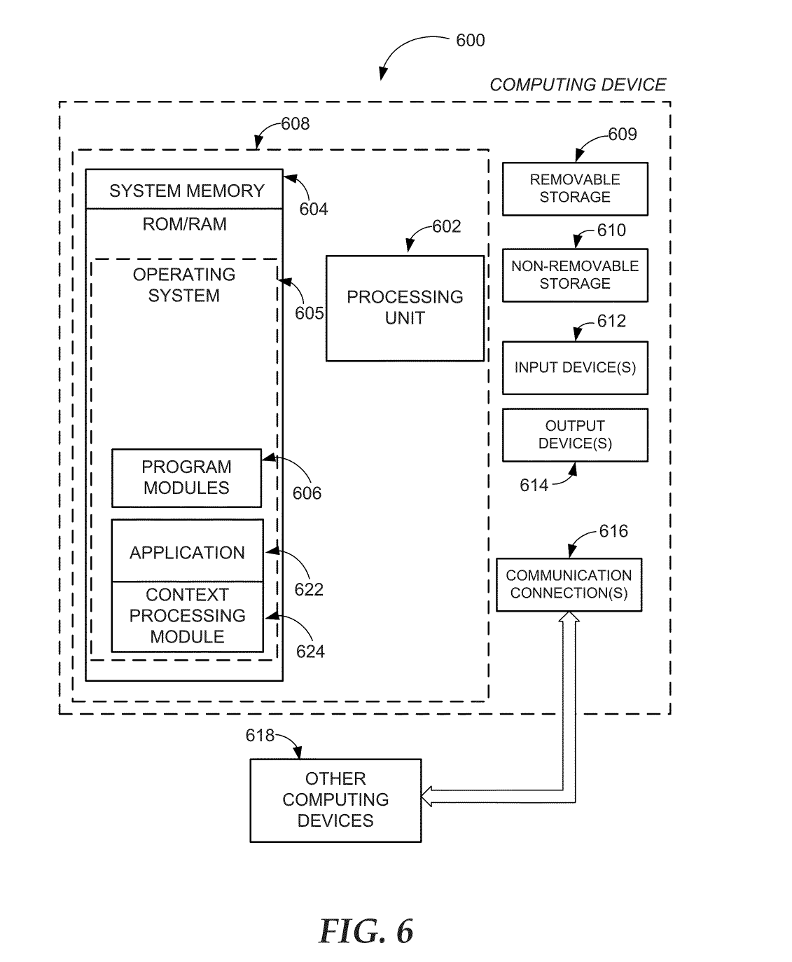

FIG. 6 and the associated discussion are intended to provide a brief, general description of a suitable computing environment in which embodiments may be implemented. With reference to FIG. 6, a block diagram of an example computing operating environment for an application according to embodiments is illustrated, such as computing device 600. In a basic configuration, computing device 600 may be any portable computing device with wireless communication capabilities, which may include touch and/or gesture detection capability in some examples, and include at least one processing unit 602 and system memory 604. Computing device 600 may also include multiple processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 606 suitable for controlling the operation of the platform, such as the WINDOWS®, WINDOWS MOBILE®, or WINDOWS PHONE® operating systems from MICROSOFT CORPORATION of Redmond, Wash. The system memory 604 may also include one or more software applications such as application 622, and a context processing module 624.

The application 622 may determine metadata information associated with a document of the application. The metadata information may include a status, an amount, and/or a context of the metadata associated with annotations on the document. The status and amount of metadata may be determined mechanically by the application 622. A context of the metadata may be processed by a context processing module 624 to determine the context of the metadata. The application 622 may then display an annotation hint to one or more users through a user interface associated with the application to indicate the status, the amount, and/or the context of the metadata without invocation of the metadata. The annotation hint may be displayed near a location within the document where the metadata is located. The application 622 may further enable the one or more users to select another annotation hint to replace the displayed annotation hint in response to invocation of the metadata through interaction with the user interface. The application 622 and the context processing module 624 may be separate applications or integrated modules of a hosted service. This basic configuration is illustrated in FIG. 6 by those components within dashed line 608.

Computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer readable storage media may include volatile and nonvolatile, removable and non-removable media implemented in any method or technology for storage of information, such as computer readable instructions, data structures, program modules, or other data. System memory 604, removable storage 609 and non-removable storage 610 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer readable storage media may be part of computing device 600. Computing device 600 may also have input device(s) 612 such as keyboard, mouse, pen, voice input device, touch input device, an optical capture device for detecting gestures, and comparable input devices. Output device(s) 614 such as a display, speakers, printer, and other types of output devices may also be included. These devices are well known in the art and need not be discussed at length here.

Some embodiments may be implemented in a computing device that includes a communication module, a memory device, and a processor, where the processor executes a method as described above or comparable ones in conjunction with instructions stored in the memory device. Other embodiments may be implemented as a computer readable memory device with instructions stored thereon for executing a method as described above or similar ones. Examples of memory devices as various implementations of hardware are discussed above.

Computing device 600 may also contain communication connections 616 that allow the device to communicate with other devices 618, such as over a wired or wireless network in a distributed computing environment, a satellite link, a cellular link, a short range network, and comparable mechanisms. Other devices 618 may include computer device(s) that execute communication applications, web servers, and comparable devices. Communication connection(s) 616 is one example of communication media. Communication media can include therein computer readable instructions, data structures, program modules, or other data. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

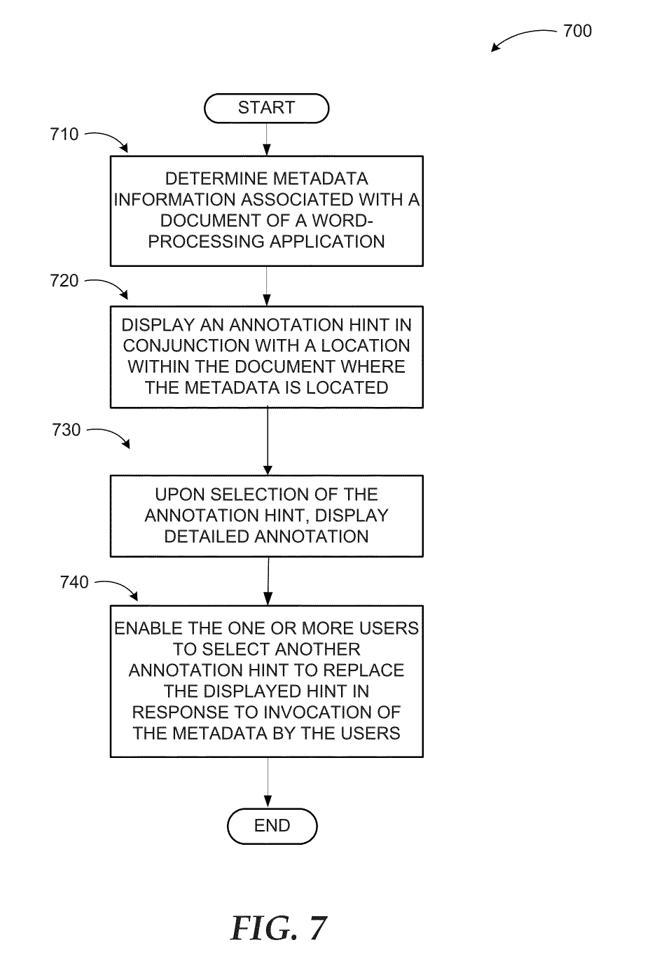

FIG. 7 illustrates a logic flow diagram for process 700 of a method to display an annotation hint in conjunction with a document viewing application according to embodiments. Process 700 may be implemented on a server or other system.

Process 700 begins with operation 710, where the application may determine a status, an amount, and/or a context of metadata associated with annotations on a document of the application. The status and amount of metadata may be determined mechanically by the application. For example, the status of the metadata may include read, selected, new and/or completed, and the amount of metadata may include a number of pieces and/or sub-pieces of metadata. A context processing module of the application my process content of the metadata to determine the context. For example, the context may include a question, an urgent or important comment, and/or typographical error.

At operation 720, an annotation hint may be displayed to one or more users through a user interface associated with the application to indicate the status, amount, and/or context of the metadata without invocation of the metadata. The annotation hint may be displayed in conjunction with a location within the document where the metadata is located. The annotation hint may be displayed using a textual scheme, a graphical scheme, an animation scheme, a coloring scheme, a highlighting scheme, and/or a shading scheme to enhance the display of the annotation hints in the user interface. For example, to indicate two or more pieces of metadata associated with a first paragraph of a document are new, two unshaded graphical icons with an animated star may be displayed through the user interface in conjunction with the first paragraph of the document.

At operation 730, upon a selection or an invocation of the annotation hint, the annotation hint may expand to display detailed information about the metadata included in the annotation hint. The user may be enabled to interact with the user interface to select the annotation hints through a tap action, a swipe action, a mouse input, a pen input, a voice input, an accelerometer input, a keyboard input, and/or comparable input mechanisms. After viewing the displayed metadata, the user may make additional annotations, or may select again to hide the metadata and continue viewing the document.

At operation 740, the one or more users may be enabled to select another annotation hint to replace the displayed annotation hint through interaction with the user interface in response to invocation of the metadata by the users. Continuing with the previous example, in response to seeing two or more new pieces of metadata associated with the first paragraph of the document, a user may invoke the metadata by selecting the graphical icons. Once the user has read the metadata, the user may determine that the content of the metadata is important. In response, the user may select another annotation hint, such as two unshaded icons with an exclamation point, to indicate the two or more pieces of metadata associated with the first paragraph are important and an action should be completed in response to the metadata.

The operations included in process 700 are for illustration purposes. Annotation hint display in conjunction with an application may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method, executed at least in part by a computing device, to display an annotation hint in conjunction with a document viewed within an application, the method comprising:
determining metadata information associated with one or more annotations in the document of the application; and
displaying an annotation hint to one or more users through a user interface associated with the application to indicate the metadata information associated with the document without invocation of metadata.

2. The method of claim 1, wherein the metadata information includes one or more of a status, an amount, and a context of the metadata.

3. The method of claim 1, wherein displaying the annotation hint to the one or more users comprises:
displaying the annotation hint near a location within the document, where the metadata is located.

4. The method of claim 1, wherein displaying the annotation hint to the one or more users further comprises:
employing at least one from: a textual scheme, a graphical scheme, an animation scheme, a coloring scheme, a highlighting scheme, and a shading scheme to enhance display of the annotation hint.

5. The method of claim 4, further comprising:
employing the at least one scheme based on one of: an application default selection and a selection by the one or more users.

6. The method of claim 1, wherein a status of the metadata includes one of: read, selected, new, and completed.

7. The method of claim 1, wherein an amount of the metadata indicates multiple pieces and sub-pieces of metadata, including two or more nested annotations.

8. The method of claim 1, further comprising:
processing content of the metadata to determine a context of the metadata.

9. The method of claim 8, wherein the context of the metadata includes at least one from a set of: a question, an urgency, a creation time, an author, a like, a dislike, a follow up needed indication, a task indicator, an assignment for action, a spelling error, a formatting error, a grammatical error, and a typographical error.

10. The method of claim 1, further comprising:
enabling the one or more users to select another annotation hint to replace the displayed annotation hint through interaction with the user interface in response to invocation of the metadata by the one or more users.

11. The method of claim 10, further comprising:
enabling the one or more users to interact with the user interface by one or more of: a touch input, a gesture input, a mouse input, a pen input, and a keyboard input.

12. A computing device to display an annotation hint in conjunction with a document viewed within an application, the computing device comprising:
a memory;
a processor coupled to the memory, the processor executing an application and causing a user interface associated with the application to be presented to one or more users, wherein the application is configured to:
identify annotation metadata associated with the document;
display an annotation hint to the one or more users through the user interface associated with the application in conjunction with a location within the document, where the annotation metadata is located, to indicate the identified annotation metadata associated with the document without invocation of the metadata; and
enable the one or more users to select another annotation hint to replace the displayed annotation hint in response to invocation of the annotation metadata by the one or more users.

13. The computing device of claim 12, wherein the application is further configured to determine one or more of a status, an amount, and a context of the annotation metadata.

14. The computing device of claim 13, wherein a context processing module of the application is configured to determine the context the annotation metadata within the document.

15. The computing device of claim 14, wherein the context of the annotation metadata includes one or more of: a question, an urgency, a creation time, an author, a like, a dislike, a follow up needed indication, a task indicator, an assignment for action, a spelling error, a formatting error, a grammatical error, and a typographical error.

16. The computing device of claim 12, wherein the application is further configured to employ one or more of: a textual scheme, a graphical scheme, an animation scheme, a coloring scheme, a highlighting scheme, and a shading scheme to enhance display of the annotation hint.

17. The computing device of claim 16, wherein a scheme for enhancing display of the annotation hint is predefined and configurable by the one or more users.

18. A computer readable memory device with instructions stored thereon to display an annotation hint in conjunction with an application, the instructions comprising:
determining one or more of a status, an amount, and a context of annotation metadata associated with a document processed by the application;
displaying the annotation hint through a user interface associated with the application near a location within the document, where the metadata is located, in order to indicate one or more of the status, the amount, and the context of the metadata associated with the document without invocation of the metadata;
enabling the one or more users to select the annotation hint to invoke and display the annotation metadata; and
enabling the one or more users to select another annotation hint to replace the displayed annotation hint in response to invocation of the annotation metadata by the one or more users.

19. The computer readable memory device of claim 18, wherein the status, the amount, and the context of annotation metadata include one or more of:
an identity of an author of the annotation, a number of related annotations, an urgency of the annotation, a new annotation, a read annotation, a selected annotation, a question within the annotation, and a grammar issue within the annotation, a formatting issue within the annotation, and a spelling issue within the annotation.

20. The computer readable memory device of claim 18, wherein the application is one of: a word processing application, a spreadsheet application, a presentation application, and a browser application.
